(19) United States
(12) Patent Application Publication
(10) Pub. No.: US 2005/0246199 A1
(43) Pub. Date: Nov. 3, 2005

(54) Health and wellness station

(76) Inventor: Tom Futch, Rochester, NY (US)

Correspondence Address: INGRASSIA FISHER & LORENZ, P.C., 7150 E. CAMELBACK, STE. 325, SCOTTSDALE, AZ, 85251, US

(21) Appl. No.: 10/838,506

(22) Filed: May 3, 2004

(51) Int. Cl. G06F 17/60

(52) U.S. Cl. 705/2

(57) ABSTRACT

A health and wellness station having a plurality of emergency response resources incorporated into a single unit is provided to a customer. A method is provided of deploying the health and wellness station and includes the steps of determining components for the health and wellness station, providing a station having the determined components to a customer, and monitoring the components of the station for maintenance and readiness. The station includes an automated external defibrillator (AED) and may have any variety of additional resources, such as a bioterror response kit, a first aid kit, a fire extinguisher, a security system, an oxygen dispenser, and other domestic preparedness items.

### TECHNICAL FIELD

The present invention relates generally to systems for first aid, safety, and security, and more particularly to maintenance and monitoring of health and wellness stations having components for responding to multiple health hazard scenarios.

### BACKGROUND

Communities, businesses, organizations, individuals, and households are all concerned with identifying and recognizing potential health and wellness hazards and taking measures to provide adequate response upon occurrence of such hazards. For example, many commercial businesses and residences incorporate security systems having external monitoring services that respond to unauthorized intrusions. Some home and work sites may have on-site first aid kits to provide bandages for managing a variety of injuries. To some degree, having at least some appropriate resources for responding to a hazard instills a sense of confidence and peace of mind in the respective community, business, organization, individual, and household.

More recently with the advent of medical resources applied to a community environment, a greater variety and number of resources are available for responding to different health and wellness hazards. One example is that a variety of automated external defibrillator (AED) types have been developed for cardiac arrest applications. Cardiac arrest is a condition where the heart stops beating and is typically a result of an arrhythmia, or abnormal rhythm, of the heart. One method of treating cardiac arrest is to restart beating of the heart using an AED. Some AEDs are designed to accommodate operators having different levels of training, frequency of AED use, and particular needs associated with different applications. For example, one AED may be designed to meet the needs of emergency response and occupational health personnel who may frequently use the AED, while another AED may be designed to meet the needs of an operator with little or no experience with AED use or rendering first aid.

One concern with providing adequate response to health and wellness hazards is choosing appropriate resources for responding to different hazards. For example, selecting the appropriate AED and related services may vary according to user experience and needs. Additional concerns for a particular resource may include state and local legislative requirements, training, and locating resources at a particular site(s). For example, some medical resources, such as AEDs, may have support services integrated with the use of the same and may require state registration and notification. Furthermore, some resources may require periodic readiness confirmation or maintenance. For example, AEDs have electrode pads and batteries that may require replenishment and fire extinguishers may require periodic recharge.

Another concern is with manageability of multiple resources or a variety of resources available for responding to hazards. In general, a number of resources may be available at one site for responding to hazards. For example, a residence may have a security system with interactive control panels located in an entry way and a master bedroom. The same home may also have a fire extinguisher located in a kitchen and a first aid kit located in a garage. The different locations of these resources generally create some inconvenience and may possibly create confusion when attempting to recall such locations, particularly in times of emergencies.

Accordingly, it is desirable to provide a health and wellness station incorporating a variety of resources for emergency preparedness into a single unit or location at a site. It is also desirable to provide a health and wellness station that may be configured for more consistent deployment across a number of sites or facilities. In addition, it is desirable to provide monitoring of components of the health and wellness station for maintenance and readiness. Furthermore, other desirable features and characteristics of the present invention will become apparent from the subsequent detailed description of the invention and the appended claims, taken in conjunction with the accompanying drawings and this background of the invention.

### BRIEF SUMMARY

According to various exemplary embodiments, a health and wellness station having a plurality of emergency response resources incorporated into a single unit is provided to a customer. In one exemplary embodiment, a method is provided of deploying the health and wellness station. The method includes the steps of determining components for a health and wellness station having an automated external defibrillator (AED), providing a station having the determined components to a customer, and monitoring the components of the station for maintenance and readiness.

In another exemplary embodiment, a method is provided of deploying an emergency response kit. The method includes the steps of establishing a contractual relationship with a customer for at least one emergency response kit having a plurality of components, providing the emergency response kit to the customer in exchange for a predetermined monetary amount, and monitoring the selected emergency response kit for maintenance and readiness of the plurality of components. An AED is included among the components of the emergency response kit.

### BRIEF DESCRIPTION OF THE DRAWINGS

The foregoing and other aspects and attendant advantages of the invention will become more readily appreciated as the same becomes better understood by reference to the following detailed description, when taken in conjunction with the accompanying drawings, wherein:

FIG. 1 is a diagram of a first exemplary embodiment of a health and wellness station;

FIG. 2 is a diagram of a second exemplary embodiment of a health and wellness station;

FIG. 3 is a diagram of a third exemplary embodiment of a health and wellness station; and

FIG. 4 is a flow chart of an exemplary embodiment of a method of deploying a health and wellness station.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary, brief description of the drawings, or the following detailed description.

Reference to “customer” herein is in the context of any entity such as an individual, a business, or a group, or affiliate, subsidiary, employee, or agent of such entity, having or desiring to enter a contractual relationship with a station provider.

According to various embodiments, a health and wellness station is provided that incorporates a variety of resources for emergency preparedness into a single unit or location at a site. The station may be customized according to a customer's requirements such that resources are available and relatively convenient for responding to different potential emergencies or hazards. The resources may be selected based upon potential hazards that may occur at a location of the station, experience and/or degree of training of personnel who may operate the station, and specific features desired of each resource. A contractual relationship is entered between the station provider and the customer to either purchase or lease the station(s) for a pre-determined period of time. Monitoring of the station may also be included in the contractual relationship for maintenance and readiness of the station.

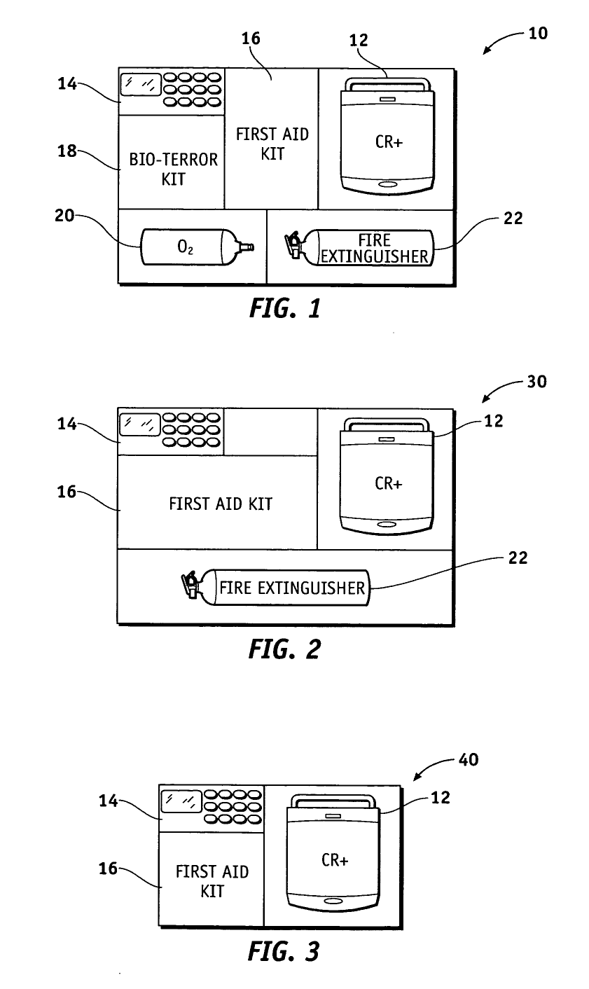

Referring now to the drawings, FIG. 1 is a diagram of a first exemplary embodiment of a health and wellness station, shown generally at 10, FIG. 2 is a diagram of a second exemplary embodiment of a health and wellness station, shown generally at 30, and FIG. 3 is a diagram of a third exemplary embodiment of a health and wellness station, shown generally at 40. Although three different stations are shown in FIGS. 1, 2 and 3, other stations may be configured with a variety of different components, or resources. Each of the stations 10, 30, 40 includes at least two components where one of the components is an automated external defibrillator (AED). Examples of AEDs include LIFEPAK® 500 AED and LIFEPAK® CR Plus AED, both by Medtronic Physio-Control Corp. Other AEDs or devices including AED functions may be used as a component of the station.

In the first exemplary embodiment shown in FIG. 1, the station 10 includes an AED 12, a security system 14, a first aid kit 16, a bioterror response kit 18, an oxygen dispensing system 20, and a fire extinguisher 22. In the second exemplary embodiment shown in FIG. 2, the station 30 includes the AED 12, the security system 14, the first aid kit 16, and the fire extinguisher 22. In the third exemplary embodiment shown in FIG. 3, the station 40 includes the AED 12, the security system 14, and the first aid kit 16. Although the foregoing components are included in the respective stations, any number and variety of other conventional emergency response resources may be included in the stations, such as an axe, a fire blanket, etc.

A variety of domestic preparedness items may also be selected or added as components of the station 10, 30, 40. Emergency evacuation hoods, nuclear radiation counteragents, and antibiotics, are a few examples of additional resources that are commonly available for response to mass destruction/casualty emergency. These resources may be included as part of the bioterror response kit 18 or as a separate component(s) of the station 10, 30, 40.

In one embodiment, the station 10, 30, 40 is positioned at a site, or multiple sites depending on the customer's requirements, and at a location that is convenient for access by the customer. In this embodiment, the station 10, 30, 40 may be considered as dispensing one or more components in response to an emergency or hazard. Having all components of the station at one location of a site generally assists customer response to emergencies or other hazards. In another embodiment, the station 10, 30, 40 includes a portable unit that may be moved from a “home” location, for example, to an accident location at or near the site. In this embodiment, the portable unit includes all of the components of the station 10, 30, 40 such that all components may be mobilized to the accident location. This embodiment allows mobility of all components in a single portable unit, such as a backpack kit including desired components, instead of selectively removing one or more components of the station for emergency response. Alternatively, the portable unit may be customized to include pre-determined component groupings of two or more components of the station.

The security system 14 may be a conventional home security system monitor that is connected with various sensors around a house, such as motion detectors, smoke alarms, and door/window sensors. Alternatively, the security system 14 may be a conventional security system used in commercial buildings that is connected to various sensors and subsystems, such a fire alarm subsystem. The security system 14 may also have external monitoring described in greater detail hereinbelow. The first aid kit 16 may generally include a variety of dressings, bandages, medical tape, ointments, and a number of other essential medical products for rendering basic medical aid. The bioterror response kit 18 may include a number of items for responding to bio-chemical related hazards such as air filters, gas masks, protective body suits and outerwear, atropine and other pharmaceuticals used as counteragents to bio-chemical hazards. The oxygen dispensing system 20 may be a conventional oxygen tank with an associated mask, an air line, and a valve. The fire extinguisher 22 may be any conventional fire extinguisher. Although the specific sizes of the various components of the station are not critical, it is generally desirable that the various components of the station be sized for convenient access at the station.

In embodiments of the station that include the security system, the station may communicate with a central response center via telecommunication lines, coaxial cable, a wireless transceiver, or other conventional communication medium. The central response center may provide monitoring services for the station and operators of the components of the station. Additionally, the station may provide emergency response support via communication with the central response center. For example, currently an AED is a medical device that may require a prescription for purchase. In addition, some states require on-going medical oversight for certain instances when using the AED. The communication between the station and the central response center may be configured to receive medical support. Although the central response center is described in the context of a single provider of services, the particular services may be outsourced to third parties while being routed through the central response center.

The monitoring services may include a link to an emergency care provider, such as a cardiologist or primary care physician. The emergency care provider can provide remote care and monitoring of a variety of medical-related conditions, such as pacemaker operation, diabetes and insulin management, cholesterol/lipid levels, and other therapies and drug management. For example, in the event an emergency medical technician (EMT) is using the station or a component thereof, an emergency room physician can direct the EMT to administer medication. In another example, the emergency care provider can provide remote care and monitoring of residential customers such as 9-1-1 emergency assistance and monitoring of the elderly.

The health and wellness station may further include a memory having an updateable table of maintenance data based on the components of the station. A processor is connected with the memory to indicate maintenance requirements of the components based on the maintenance data. For example, a component or a part of such component may have a pre-determined shelf-life that approximates readiness of such component or component part. Upon expiration of such shelf-life, the component or part may need to be replaced. The maintenance data includes this shelf-life data, and the processor may periodically determine expiration times for a component based on the maintenance data and alert the customer and/or the station provider of the same.

In another embodiment, the central response center may have memory storing the maintenance data associated with the respective components of the station. For example, the central response center may have maintenance data regarding the shelf-life of electrodes and current battery level of the AED. Upon expiration of the electrode shelf-life or detection of a low battery level of the AED, the central response center may indicate a maintenance alert to the customer through any number of ways. For example, the central response center may remotely activate a visual indicator on the station that maintenance is required of a particular component, or the central response center may communicate directly with the customer to provide the maintenance alert.

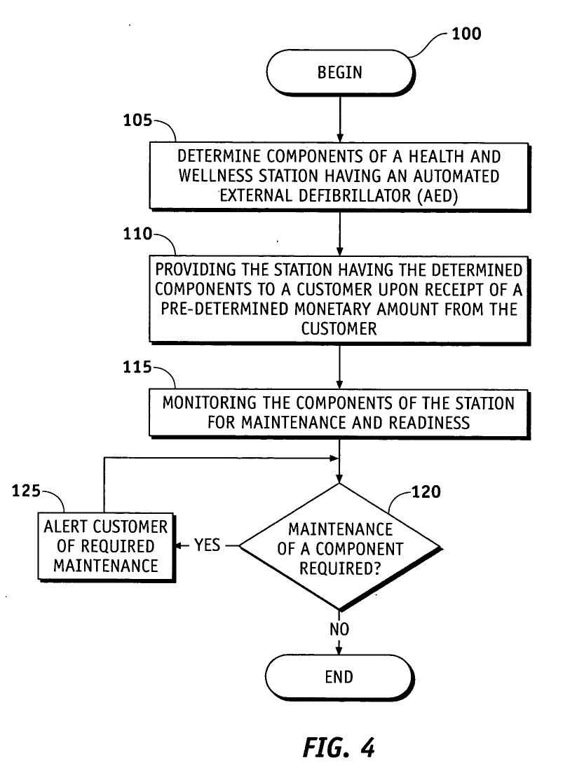

FIG. 4 is a flow chart of an exemplary embodiment of a method of deploying a health and wellness station. The method begins at 100. Components for the health and wellness station 10, 30, 40 having an automated external defibrillator (AED) 12 are determined at 105. In one embodiment, at least one component of the station 10, 30, 40 is selected from among a security system 14, a first aid kit 16, a bioterror response kit 18, an oxygen dispensing system 20, and a fire extinguisher 22. The components may be selected based on potential hazards that may be encountered at a customer location, customer or operator experience with particular components of the station, and customer or operator training with particular components of the station.

A customer is provided the station at step 110 having the components determined from step 105. In one embodiment, the customer is provided a station from three pre-configured stations: a first station 10 having the AED 12, the security system 14, the first aid kit 16, the bioterror response kit 18, the oxygen dispensing system 20, and the fire extinguisher 22; a second station 30 having the AED 12, the security system 14, the first aid kit 16, and the fire extinguisher 22; and a third station 40 having the AED 12, the security system 14, and the first aid kit 16. As previously mentioned hereinabove, the station 10, 30, 40 may be configured to include a variety of additional components including, by way of example and not of limitation,

The station is provided to the customer upon receipt of a pre-determined monetary amount from the customer. In this embodiment, a contractual relationship is established and maintained between the customer and the station provider for a period of time in exchange for the pre-determined monetary amount. The contractual relationship may be a purchase arrangement where the customer purchases the station(s) from the station provider and pays a pre-determined sum amount or makes periodic payments for the station. The customer may also make periodic payments for monitoring service of the station. Each of the foregoing periodic payments may be made annually, monthly, or any other regular interval. The contractual relationship may also be a lease arrangement based upon receipt of a lease payment. For example, the customer may enter a three-year lease option for the station with periodic monthly payments of a pre-determined monetary amount. In another example, the customer can purchase the station outright and include a three-year service contract for monitoring the station. The particular term of the lease or service contract is not critical.

The components of the station 10, 30, 40 are monitored for maintenance and readiness at step 115. A determination of whether a component of the station 10, 30, 40 requires maintenance is made at step 120. In the event one or more of the components of the station 10, 30, 40 are determined to require maintenance, the customer is alerted at step 125, such as by a visual indicator. Optionally, the station 10, 30, 40 may include an additional visual indicator, such as a light or text display, that indicates that the station is ready for use.

In one embodiment, at least one of the AED 12, the security system 14, the first aid kit 16, the bioterror response kit 18, the oxygen dispensing system 20, and the fire extinguisher 22, is monitored by a central response center. When at least one of the components of the station 10, 30, 40 requires maintenance, the central response center alerts the customer of the maintenance requirement. As previously mentioned hereinabove, in one embodiment, the central response center may remotely activate a visual indicator on the station 10, 30, 40 that alerts the customer of required maintenance of the station.

In another embodiment, the station includes a processor and memory coupled thereto to determine maintenance requirements of the station components. In this embodiment, the processor may indirectly monitor the components to determine whether the shelf-life of a component has expired, based on data stored in the memory, and activate a visual indicator on the station to alert the customer of the maintenance requirement. The processor may also directly monitor the components, such as by detecting a battery level for the AED, for comparison with pre-determined thresholds stored in memory. In the event the processor detects sub-threshold levels, the processor may activate the visual indicator.

Medical direction, on-going professional management, and assistance in meeting federal, state and local requirements may further be included with the contractual relationship in providing the station and/or monitoring services for the station. For example, each state generally has AED legislation that may require owners or operators of AEDs to notify local emergency medical services (EMS) office and/or require registration and payment of registration fees. The contractual relationship may include customer assistance to complete and file appropriate forms and fees. Additionally, this relationship may also timely inform the customer of changes in regulations and help ensure that the customer complies with local, state, and federal requirements. Furthermore, site assessment and deployment priority may be provided in determining the number of stations a customer may need and the most strategic locations for placement of the stations.

As previously mentioned hereinabove, an emergency care provider link may also be included with the monitoring services provided in the contractual relationship. A physician can provide remote care and monitoring of a variety of medical-related conditions, such as pacemaker operation, diabetes and insulin management, cholesterol/lipid levels, and other therapies and drug management. For example, 9-1-1 emergency assistance may be directly accessed via the link. In another example, a third party intervener service may be directly accessed via the link to provide emergency assistance, such as support for incapacitated elderly customers.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

1. A method of deploying a health and wellness station, said method comprising the steps of:
determining components for a health and wellness station having an automated external defibrillator (AED);
providing a station having the determined components to a customer; and
monitoring the components of the station for maintenance and readiness of the components.

2. A method according to claim 1, wherein said component determining step comprises the step of selecting at least one component from the AED, a security system, a first aid kit, a bioterror response kit, an oxygen dispensing system, and a fire extinguisher.

3. A method according to claim 2, wherein said component selecting step is based on at least one of potential hazards at a customer location, customer experience with components of the station, and customer training with components of the station.

4. A method according to claim 1, wherein said station providing step comprises the step of selecting a station from one of: a first station having an automated external defibrillator, a security system, a first aid kit, a bioterror response kit, an oxygen dispensing system, and a fire extinguisher; a second station having an automated external defibrillator, a security system, a first aid kit, and a fire extinguisher; and a third station having an automated external defibrillator, a security system, and a first aid kit.

5. A method according to claim 1, wherein said station providing step comprises the steps of:
receiving a pre-determined monetary amount from the customer; and
maintaining a contractual relationship with the customer for a period of time in exchange for the pre-determined monetary amount.

6. A method according to claim 5, wherein said receiving step is performed upon purchase of the station.

7. A method according to claim 5, wherein said receiving step is performed at a regular interval corresponding to the period of time.

8. A method according to claim 7, wherein the regular interval further corresponds to a period of contract for maintenance of the station.

9. A method according to claim 7, wherein the period of time is selected from annually and monthly.

10. A method according to claim 5, wherein said receiving step is performed in conjunction with receipt of a lease payment.

11. A method according to claim 5, wherein said station providing step further comprises the step of locating the station at at least one customer site.

12. A method according to claim 5, wherein said station providing step further comprises the step of locating the station at at least one customer site, the station having a portable unit containing the components.

13. A method according to claim 2, wherein said monitoring step comprises the step of monitoring at least one of the AED, the security system, the first aid kit, the bioterror response kit, the oxygen dispensing system, and the fire extinguisher.

14. A method according to claim 13, wherein said monitoring step further comprises the step of alerting the customer when at least one of the components of the station requires maintenance.

15. A method according to claim 13, wherein said monitoring step further comprises the step of indicating to the customer that the components of the station are ready for use.

16. A method of deploying an emergency response kit, said method comprising the steps of:
establishing a contractual relationship with a customer for at least one emergency response kit having a plurality of components, the plurality of components including an AED;
providing the emergency response kit to the customer in exchange for a predetermined monetary amount; and
monitoring the selected emergency response kit for maintenance and readiness of the plurality of components.

17. A method according to claim 16, wherein said providing step comprises selecting an emergency response kit from one of: a first station having an AED, a security system, a first aid kit, a bioterror response kit, an oxygen dispensing system, and a fire extinguisher; a second station having an AED, a security system, a first aid kit, and a fire extinguisher; and a third station having an AED, a security system, and a first aid kit.

18. A method according to claim 17, wherein said providing step comprises determining the components of the emergency response kit based on customer sites, customer experience with the components, designated operators of the emergency response kit, and potential emergencies.

19. A health and wellness station comprising:
at least two components selected from an AED, a security system, a first aid kit, a bioterror response kit, an oxygen dispensing system, and a fire extinguisher;
a memory having an updateable table of maintenance data based on at least one of said at least two components; and
a processor connected with said memory and indicating maintenance requirements of said at least two components based on said maintenance data.

20. A health and wellness station according to claim 19 further comprising at least one component selected from an emergency evacuation hood, a nuclear radiation counteragent, and antibiotics.

21. A health and wellness station according to claim 20 further comprising:
a base; and
a portable unit removably coupled to said base, said portable unit containing said components.

22. A health and wellness station according to claim 19 further comprising a communication link to an emergency care provider.
